(19) United States
(12) Patent Application Publication
(10) Pub. No.: US 2013/0201188 A1
(43) Pub. Date: Aug. 8, 2013

(54) APPARATUS AND METHOD FOR GENERATING PRE-VISUALIZATION IMAGE

(71) Applicants: Yoon Seok CHOI, Daejeon (KR); Do Hyung KIM, Chungcheongbuk-do (KR); Jeung Chul PARK, Jeonju (KR); Ji Hyung LEE, Daejeon (KR); Bon Ki KOO, Daejeon (KR)

(72) Inventors: Yoon Seok CHOI, Daejeon (KR); Do Hyung KIM, Chungcheongbuk-do (KR); Jeung Chul PARK, Jeonju (KR); Ji Hyung LEE, Daejeon (KR); Bon Ki KOO, Daejeon (KR)

(73) Assignee: Electronics and Telecommunications Research Institute, Daejeon (KR)

(21) Appl. No.: 13/585,754

(22) Filed: Aug. 14, 2012

(30) Foreign Application Priority Data
Feb. 6, 2012 (KR) 10-2012-0011881

(51) Int. Cl. G06T 13/20; G06T 17/00

(52) U.S. Cl. 345/420; 345/419

(57) ABSTRACT

Disclosed is an apparatus and method for generating a pre-visualization image supporting functions of simulating interactions between the digital actor motion, the virtual space, and the virtual shooting device motion in an actual space and previewing the image by using a virtual camera and a virtual space including a 3D digital actor in an image production operation. Thus, according to the present invention, it is possible to support more effective image production.

### CROSS-REFERENCE TO RELATED APPLICATIONS

This application claims priority to and the benefit of Korean Patent Application No. 10-2012-0011881 filed in the Korean Intellectual Property Office on Feb. 6, 2012, the entire contents of which are incorporated herein by reference.

### TECHNICAL FIELD

The present invention relates to an apparatus and method for generating a pre-visualization image, and more particularly, to an apparatus and method for generating a pre-visualization image on the basis of a virtual camera.

### BACKGROUND ART

In the 1960s to the 1970s, computer graphics was mainly used for simulations based on the numerical calculation in the science/military technology field and thereafter, from the 1980s, was initially introduced to the public through the entertainment, for example, movies, games, broadcastings, etc. Up to the 1980s, 2D technologies for image composition or other technologies for video production, where a sequence of images such as animation is manually drawn, had been commonly used in the film industry.

With the advance of computer hardware, the computer graphics operations are automatized through the support of computer graphic programs such as Maya and 3D Max, thereby continuing to reduce time and cost thereof. Composition effect was considered to be the core function in early science fiction films. For example, to show a flying superman, an actor was floated in the air with a wire, which was composed with a background to produce a final image. Originally, these computer graphics operations were sufficient enough to give the impression to the audience. However, this technology itself was performed on the basis of original images and thus had a lot of difficulties in that human imagination and creativity are applied to the images.

A technique for effectively implementing the author's imagination and creativity is a digital actor technology. A digital actor is a core technology for special effects in the film/broadcasting fields. A three-dimensional actor who is represented in the same appearance as a real actor performs important roles throughout the image In a scene of a battle with the Octopus Villain in “Spider-Man 2 (2004)”, a scene of Superman flying in “Superman Returns (2006)”, and a main scene of the face of the leading actor who is born old but gradually becomes young in “The Curious Case of Benjamin Button (2008)”, the digital actors, who resemble the leading actors, respectively, are utilized Films without real actors were produced. In “Final Fantasy (2001)”, “The Polar Express (2004)”, and “Beowulf (2007)”, entire scenes were shot in 3D with digital actors.

However, a lot of technologies and computer graphics operations are necessary in film production utilizing digital actors. First, since the digital actor is not an actual actor and thus cannot move for itself in an image space, the digital actor should create or provide a motion which is introduced therein. For this, an image is produced by pre-capturing the motion of the real actor and then applying the motion to the digital actor in the scene. That is, an image of the real actor and an image of the digital actor are produced separately, post-processed, and then combined into one image.

In this case, naturalness of an image entirely depends on whether the digital actor can be accurately matched with an actual shooting scene. Especially, a scene where the actual actor should interact with the digital actor needs to be more accurately match. However, since real image shooting is performed separately from the action of the digital actor, mismatching between actions of actors, although checked in a post-processing step, cannot be modified unless the actions are not reshot.

Motion control and attribute setting in camera are very important in the image production. However, a motion or angle of a camera cannot check whether a scene desired by a director may be obtained before a real image is shot and checked. In the related art, designers manually produce 2D illustration according to an intention of a director. In a more advanced design, the designers manually designate a moving path, direction, or attribute of a camera with a 3D model to produce 3D continuity for generating images. However, this continuity provides only an approximate outline. In order to set the continuity, repetitive operations such as scene setting, camera setting, etc. and a lot of communications between those who participate in the production are required. Accordingly, the operations are very difficult and take much time. There is a problem in that considerable cost and time are consumed so that an image not suitable for original intention may be corrected through a post-edition after a real shooting scene.

### SUMMARY OF THE INVENTION

The present invention has been made in an effort to provide an apparatus and method for generating a pre-visualization image, which simulate interactions between the digital actor motion, the virtual space, and the virtual shooting device motion in the real space by using a virtual camera and a virtual space including a 3D digital actor in an image production operation and support a preview function for the image. Thus, it is possible to provide effective support for better production.

An exemplary embodiment of the present invention provides an apparatus for generating a pre-visualization image including: a motion information extraction unit extracting motion information about a real actor; a device information collection unit collecting virtual camera information, the virtual camera information being motion information about a virtual shooting device for shooting the motion of the actual actor; a pre-visualization image generation unit applying the motion information of the actor to the digital actor on the basis of the virtual camera information to generate a pre-visualization image, the pre-visualization image being a virtual scene image containing the motion of the digital actor; and a image generation control unit controlling such that the pre-visualization image is generated.

The device information collection unit may include: a virtual shooting device tracker tracking the motion of the virtual shooting camera using a marker attached to the virtual shooting device; and a position/direction information collector collecting position and direction information about the virtual shooting device, which is the virtual camera information, through the tracking.

The motion information extraction unit may extract the motion information using a marker attached to the real actor.

The apparatus may further include: a motion information correction unit correcting the motion information such that the motion information is applicable to the digital actor; or a virtual camera information correction unit correcting the virtual shooting device information with noise removal or sample simplification.

The apparatus may further include a virtual camera attribute control unit controlling an attribute of the virtual camera through a screen interface or wireless controller.

The image generation control unit may include: a virtual model data manager pre-generating or storing virtual model data which is a virtual model to be disposed in a virtual space; a virtual camera controller controlling the virtual camera in the virtual space using the virtual shooting device information collected whenever the motion information is extracted; a digital actor controller applying the motion information to the digital actor positioned in the virtual space to control the digital actor; a virtual space controller controlling the virtual space by adjusting a size or shape of the virtual space using the controlled virtual camera; a combination-based scene image generation controller performing control such that the pre-visualization image is generated, by combining the controlled digital actor and virtual camera with the virtual model data in the controlled virtual space. The image generation control unit may further include a virtual camera information initialization unit calculating relative differences in position and direction between the real shooting device in the real space and the virtual camera in the virtual space and initializing correction information about the virtual camera with the differences, and the virtual camera control unit may control the virtual camera by correcting the virtual camera information using a virtual camera value initialized whenever the motion information is extracted.

The combination-based scene image generation controller may perform control such that the pre-visualization image, which is a stereoscopic image, is generated on the basis of the virtual camera information or the pre-visualization image is simultaneously output to the virtual shooting device and the pre-visualization image generation unit with multiple screens. The combination-based scene image generation controller may control remotely over a network such that a preview image is output to the multiple screens.

The apparatus may further include a compatible data conversion unit converting at least one of the motion information, the virtual camera information, the virtual scene image, and the pre-visualization image into compatible data.

Another exemplary embodiment of the present invention provides a method of generating a pre-visualization image including: a motion information extraction step of extracting motion information about a real actor; a virtual shooting device information collection step of collecting virtual camera information which is motion information about a virtual shooting device for shooting the motion of the real actor; and a pre-visualization image generation step of applying the motion information of the actor to the digital actor on the basis of the virtual camera information to generate the pre-visualization image which is a virtual scene image containing the motion of the digital actor.

The virtual shooting device information collection step may include: a virtual shooting device tracking step of tracking the motion of the virtual shooting device using a marker attached to the virtual shooting device; and a position/direction information collection step of collecting position and direction information about the virtual shooting device, which is the virtual shooting device information, through the tracking.

The motion information extraction step may include extracting the motion information using a marker attached to the real actor.

The method may further include a motion information correction step of correcting the motion information such that the motion information is applicable to the digital actor.

The method may further include a virtual camera information correction step of correcting the camera information with noise removal or sample simplification.

The method may further include a virtual camera attribute control step of controlling an attribute of the virtual camera through a screen interface or wireless controller.

The method may further include the pre-visualization image generation control step of performing control such that the pre-visualization image is generated, in which the pre-visualization image generation control step includes: a virtual model data management step of pre-generating or storing virtual model data which is a virtual model to be disposed in a virtual space; a virtual camera control step of controlling the virtual camera in the virtual space using the virtual camera information collected whenever the motion information of the virtual shooting device is extracted; a digital actor control step of applying the motion information to the digital actor positioned in the virtual space to control the digital actor; a virtual space control step of controlling the virtual space by adjusting a size or shape of the virtual space using the controlled virtual camera; a combination-based scene image generation control step of performing control such that the pre-visualization image is generated, by combining the controlled digital actor and virtual camera with the virtual model data in the controlled virtual space. The pre-visualization image generation control step may further include a virtual camera information initialization step of calculating relative differences in position and direction between the real shooting device in the real space and the virtual camera in the virtual space and initializing correction information about the virtual camera with the differences, and the virtual camera control step may include controlling the virtual camera by correcting the virtual camera information using a virtual camera value initialized whenever the motion information is extracted.

The method may further include a compatible data conversion step of converting at least one of the motion information, the virtual camera information, the virtual scene image, and the pre-visualization image into compatible data.

The present invention may have the following effects. First, it is possible to provide a function of fully previewing an image which is produced by using the digital actor and the virtual space on the basis of the same real-time actor motion extraction function and virtual shooting device function as those in a real image production environment. Second, it is possible to provide a function of managing data collected during the shooting and replaying the data at any time. Third, it is possible to check a result through the pre-visualization image in a data collection step, unlike an existing operation method of checking the result of the image after collecting data and then generating an image. Fourth, it is possible to simulate the motion of the shooting device based on the virtual space to predetermine the camera setting for image production and reduce repetitive operations such as 3D special effects, camera composition setting, etc. in an actual shooting site, thereby shortening a production period and reducing cost.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically showing an apparatus for generating a pre-visualization image according to an exemplary embodiment of the present invention.

FIG. 2 is a block diagram showing additional elements of the apparatus shown in FIG. 1.

FIGS. 3A and 3B are a block diagram showing in detail an internal configuration of the apparatus shown in FIG. 1.

FIG. 4 is a configuration diagram of a pre-visualization apparatus based on a marker and a tracking device.

FIG. 5 is a block diagram of the pre-visualization apparatus based on the marker and the tracking device.

FIG. 6 is a block diagram showing an internal configuration of a virtual shooting device tracking unit.

FIG. 7 is a block diagram showing an internal configuration of an actor motion tracking unit.

FIG. 8 is a block diagram showing an internal configuration of a data post-processing unit.

FIG. 9 is a block diagram showing an internal configuration of a virtual shooting device attribute control unit.

FIG. 10 is a block diagram showing an internal configuration of a scene control unit.

FIG. 11 is a block diagram showing an internal configuration of an image generation unit.

FIG. 12 is a conceptual view illustrating a process of extracting a motion from an actor performing an action and then outputting the motion to a screen of a virtual shooting device.

FIG. 13 is a flow chart illustrating a process of correcting a camera position value and a camera direction value for an extraction camera position.

FIG. 14 is a flow chart schematically illustrating a method of generating a pre-visualization image according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

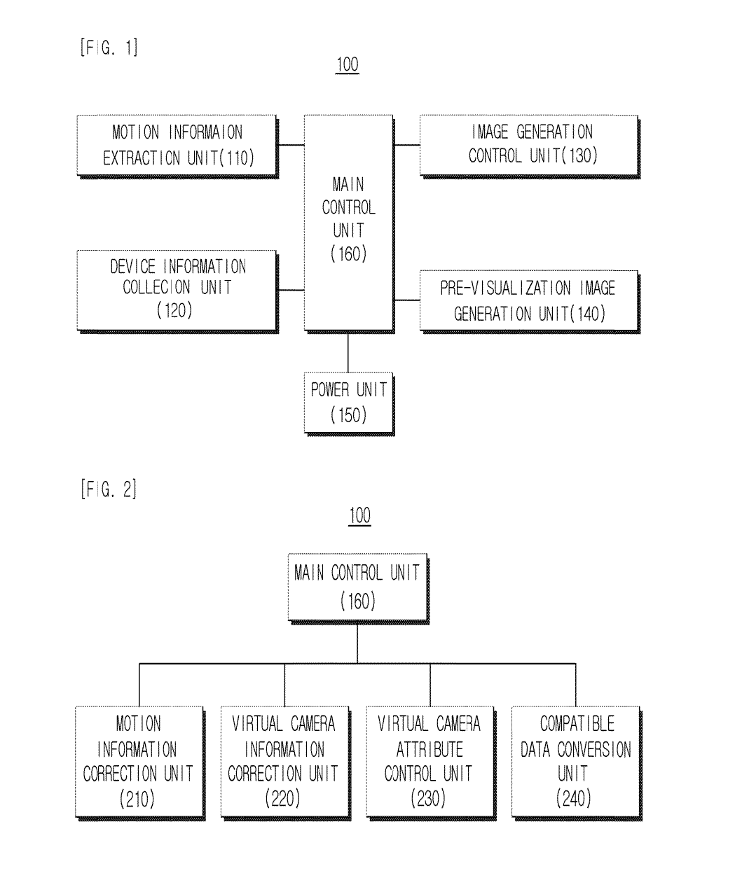

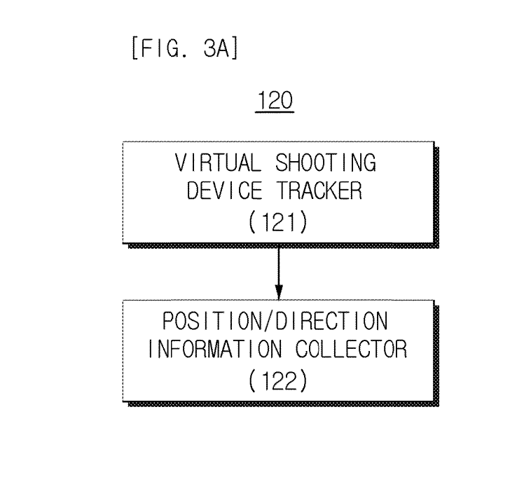

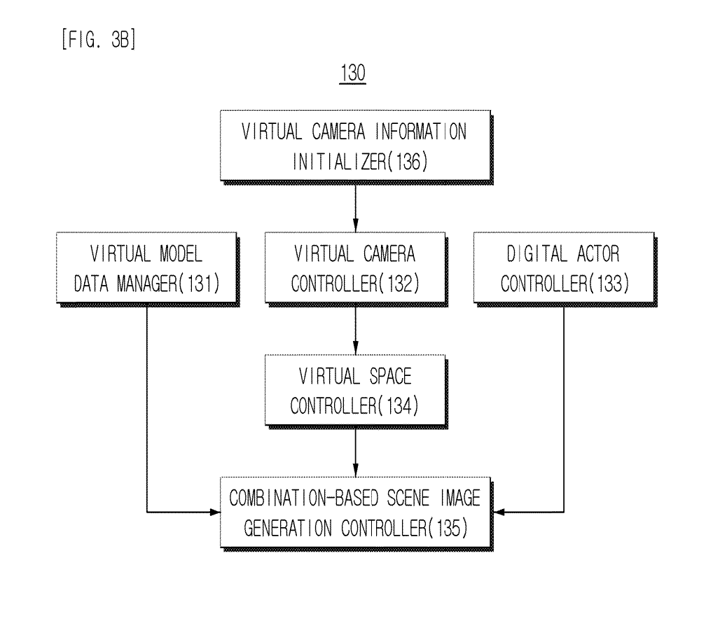

FIG. 1 is a block diagram schematically showing an apparatus for generating a pre-visualization image according to an exemplary embodiment of the present invention. FIG. 2 is a block diagram showing additional elements of the apparatus shown in FIG. 1. FIGS. 3A and 3B are a block diagram showing in detail an internal configuration of the apparatus shown in FIG. 1. The following description will be made with reference to FIGS. 1 to 3B.

A motion information extraction unit 110 extracts motion information about a real actor. The motion information extraction unit 110 may extract the motion information using a marker attached to the real actor. The motion information extraction unit 110 performs the same function as an actor motion tracking unit as described below.

A device information collection unit 120 collects virtual camera information which is motion information about a virtual shooting device for shooting the motion of the real actor. The device information collection unit 120 performs the same function as a virtual shooting device tracking unit as described below.

The device information collection unit 120 may include a virtual shooting device tracker 121 and a position/direction information collector 122 as shown in FIG. 3A. The virtual shooting device tracker 121 tracks the motion of the virtual shooting device using a marker attached to the virtual shooting device in a real space. The position/direction information collector 122 collects position or direction information about the virtual camera, which is the virtual shooting device information by tracking the virtual shooting device.

A pre-visualization image generation unit 140 applies the motion information about the actor, who is positioned in the real world, to the digital actor on the basis of the virtual shooting device information to generate a pre-visualization image which is a virtual scene image of a combination of movements of the digital actor and the virtual camera. The pre-visualization image generation unit 140 may apply motion information, which is extracted whenever the motion of the actor positioned in the real world is extracted, to the digital actor to generate the pre-visualization image which is a virtual scene image applying the motion of the digital actor. In the present embodiment, the actor positioned in the real world denotes an actor mainly moving in the real world, and the digital actor denotes an actor moving in the virtual space according to the motion of the actor positioned on the real world. The pre-visualization image generation unit 140 performs the same function as an image generation unit as described below.

The image generation control unit 130 performs control such that the pre-visualization image is generated. The image generation control unit 130 performs the same function as a scene control unit as described below.

The image generation control unit 130 may include a virtual model data manager 131, a virtual camera controller 132, a digital actor controller 133, a virtual space controller 134, and a combination-based scene image generation controller 135, as shown in FIG. 3B. The virtual model data manager 131 pre-generates or stores virtual model data including a virtual model of a digital actor, a background building, etc. which are disposed in the virtual space. The virtual model data manager 131 performs the same function as a scene manager as described below. The virtual camera controller 132 controls the virtual camera using the virtual camera information which is collected whenever the motion information is extracted. The virtual camera controller 132 performs the same function as a scene camera controller as described below. The digital actor controller 133 applies the motion information about the real actor to the digital actor positioned in the virtual space to control the digital actor. The digital actor controller 133 performs the same function as an actor motion controller as described below. The virtual space controller 134 adjusts a size or shape of the virtual space using the controlled virtual camera to control the virtual space. The virtual space controller 134 performs the same function as a virtual space adjuster as described below. The combination-based scene image generation controller 135 combines the controlled digital actor and virtual camera with the virtual model data in the controlled virtual space to perform control such that the pre-visualization image is generated. The combination-based scene image generation controller 135 may perform control such that the pre-visualization image, which is a stereoscopic image, is generated on the basis of the virtual camera information. The combination-based scene image generation controller 135 may perform control such that the pre-visualization image is simultaneously output with multiple screens to the virtual shooting device and the pre-visualization image generation unit. In this case, the combination-based scene image generation controller 135 may perform remote control over a network such that a preview image is output to the multiple screens.

The image generation control unit 130 may further include a virtual camera information initializer 136 as shown in FIG. 3B. The virtual camera information initializer 136 calculates relative differences in position and direction between the real shooting device in the real space and the virtual camera in the virtual space and then initializes correction information about the virtual camera using the differences. In this case, the virtual camera controller 132 may apply the initialized virtual camera value to the virtual camera information collected whenever the motion information is extracted, to correct the virtual camera information to control the virtual camera. The virtual camera information initializer 136 performs the same function as a virtual camera initializer as described below.

The pre-visualization image generation apparatus 100 may further include a motion information correction unit 210, a virtual camera information correction unit 220, a virtual camera attribute control unit 230, and a compatible data conversion unit 240 as shown in FIG. 2.

The motion information correction unit 210 corrects the motion information such that the motion information is applicable to the digital actor. The virtual camera information correction unit 220 corrects the virtual camera information with noise removal or sample simplification. The motion information correction unit 210 and the virtual camera information correction unit 220 perform the same function as a data post-processing unit as described below.

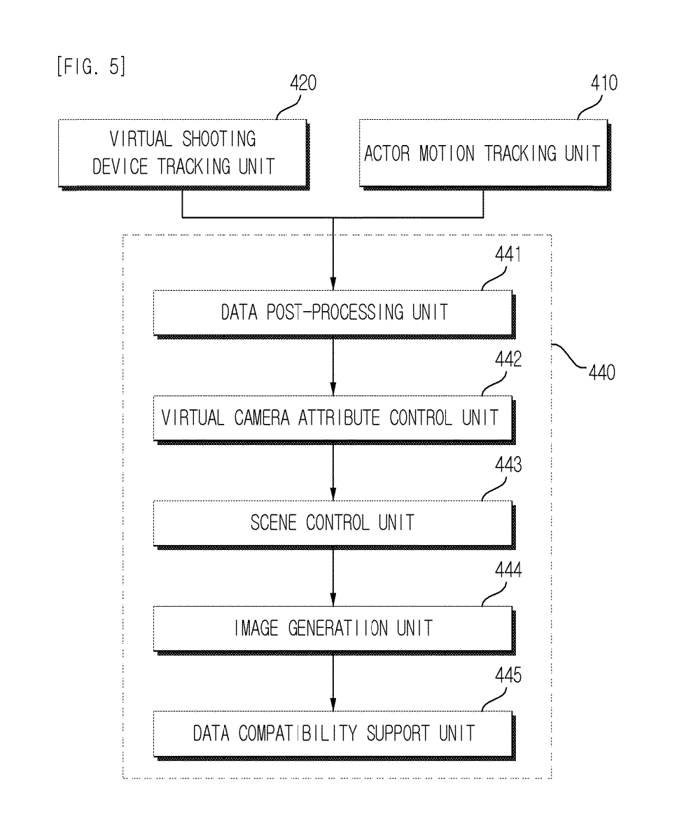

The virtual camera attribute control unit 230 controls an attribute of the virtual camera through a screen interface or wireless controller. The virtual camera attribute control unit 230 performs the same function as a virtual camera attribute control unit of FIG. 5.

The compatible data conversion unit 240 converts at least one of the real actor motion information, the virtual camera information, the virtual scene image, and the pre-visualization image into compatible data.

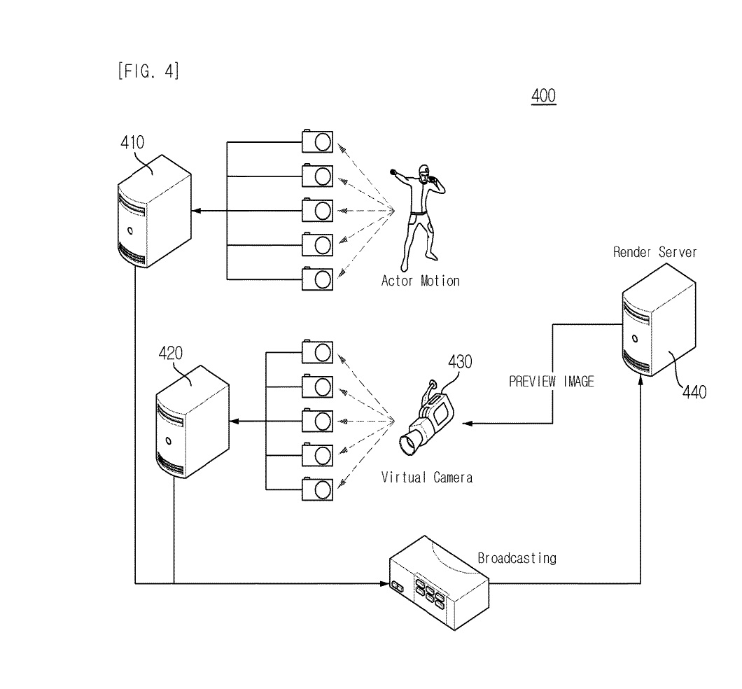

Next, a pre-visualization apparatus based on a virtual camera for image production (hereinafter, referred to simply as a pre-visualization apparatus) will be described as an embodiment of the pre-visualization image generation apparatus 100. FIG. 4 is a conceptual diagram of the pre-visualization apparatus based on a marker and a tracking device. FIG. 5 is a block diagram of the pre-visualization apparatus based on the marker and the tracking device. The following description will be made with reference to FIGS. 4 and 5.

The pre-visualization apparatus 400 simulates interactions between the digital actor motion, the virtual space, and the virtual shooting device motion in an actual space production by using a virtual shooting device and a virtual space including a 3D digital actor in an image production operation and supports an image preview function, thereby allowing more effective image production. Characteristics of the pre-visualization apparatus 400 are summarized as follows. First, the pre-visualization apparatus 400 tracks in real-time and processes motions of a camera and an actor, where an image production support system is established. Second, the pre-visualization apparatus 400 transmits the collected data to an image server, and on the basis of this, applies the position of the camera and the motion of the actor to the virtual space to produce in real-time the pre-visualization image. Third, the pre-visualization apparatus 400 controls attributes such as FOV (field of view) or Zoom In/Out. Fourth, the pre-visualization apparatus 400 stores and manages information for production of the pre-visualization image, reproduces the pre-visualization image, and produces video with the pre-visualization image. Fifth, the pre-visualization apparatus 400 provides compatibility for general purposes of the collected camera information and actor motion information to utilize the collected information to another application program.

For this, the pre-visualization apparatus 400 includes a virtual shooting device 430, a virtual shooting device tracking unit 420 collecting marker-based camera device motion information, an actor motion tracking unit 410 tracking a marker-based actor motion, and a service control device (render server; 440). The service control device 440 includes a data post-processing unit 441 managing and processing the collected data, a scene control unit 443 managing data needed to establish the a virtual space, such as the virtual shooting device motion information and an actor motion information and providing a function of configuring a scene, an image generation unit 444 generating an virtual space image and a pre-visualization image thereof, and a data compatibility support unit 445 allowing the stored virtual camera motion information and actor motion information to be utilized in other fields.

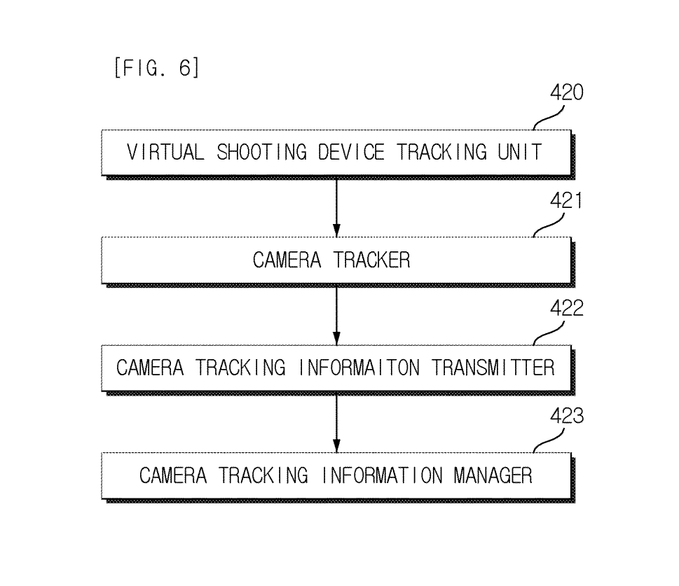

FIG. 6 is a block diagram showing an internal configuration of the virtual shooting device tracking unit. As shown in FIG. 6, the virtual shooting device tracking unit 420 includes a camera tracker 421 collecting position and direction information about the virtual shooting device on the base of the marker, a camera tracking information transmitter 422 transmitting the collected camera information to a server, and a camera tracking information manager 423 storing and managing the transmitted tracking information. The camera tracking information transmitter 422 transmits in real-time the collected position and direction information to the server over a network.

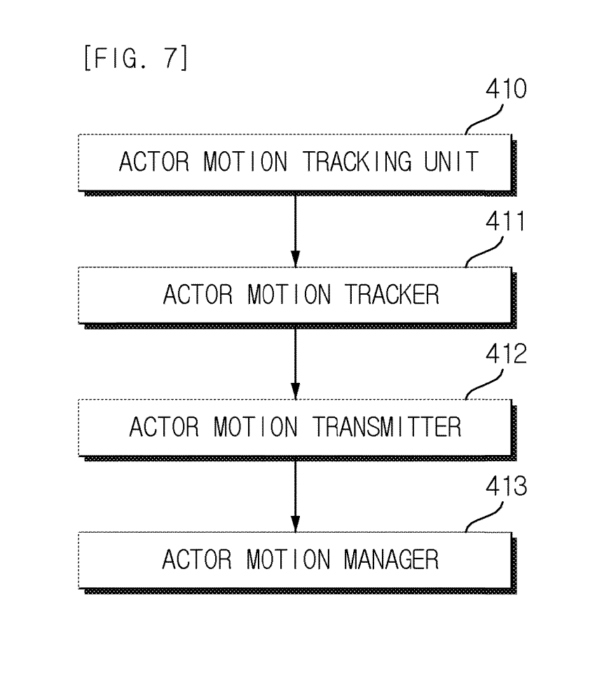

FIG. 7 is a block diagram showing an internal configuration of the actor motion tracking unit. As shown in FIG. 7, the actor motion tracking unit 410 includes an actor motion tracker 411 collecting motion information about an actor on the base of a marker attached to the actor, an actor motion transmitter 412 transmitting the collected motion information to the server, an actor motion management unit 413 storing and managing the transmitted motion information. The actor motion transmission unit 412 transmits in real-time the collected image to the server through the network.

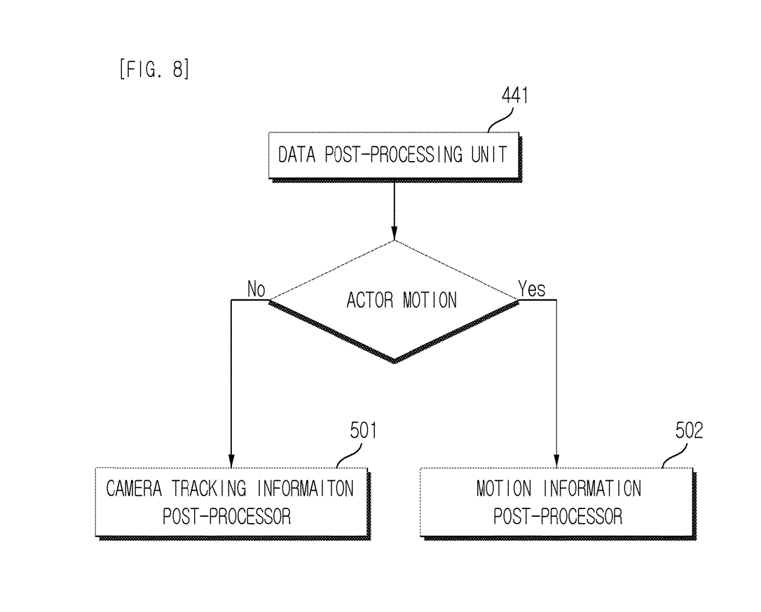

FIG. 8 is a block diagram showing an internal configuration of the data post-processing unit. As shown in FIG. 8, the data post-processing unit 441 includes a camera tracking information post-processor 501 providing operations such as noise removal, sample simplification, etc. for the stored virtual shooting device motion information and a motion information post-processor 502 matching the actor motion information to a 3D actor.

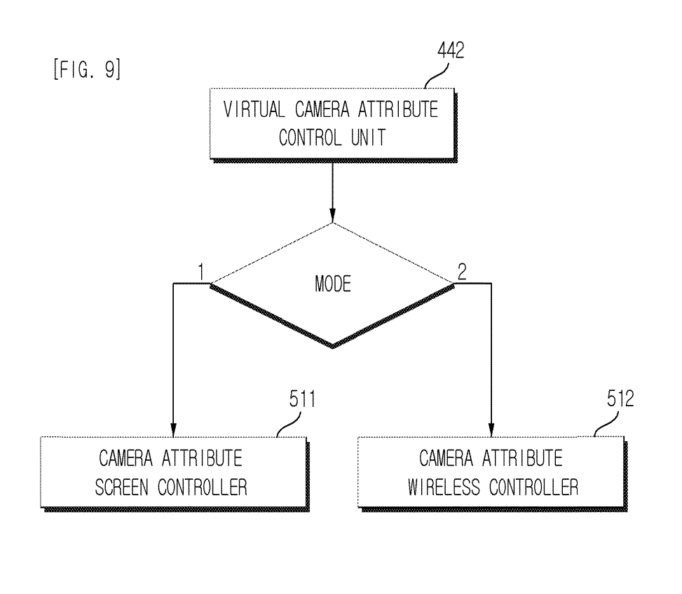

FIG. 9 is a block diagram showing an internal configuration of the virtual camera attribute control unit. As shown in FIG. 9, the virtual camera attribute control unit 442 includes a camera attribute screen controller 511 controlling attributes of FOV (field of view) or Zoom In/Out of the virtual camera through a screen user interface (UI) and a camera attribute wireless controller 512 controlling the attributes of FOV (field of view) or Zoom In/Out of the virtual camera through a wireless controller.

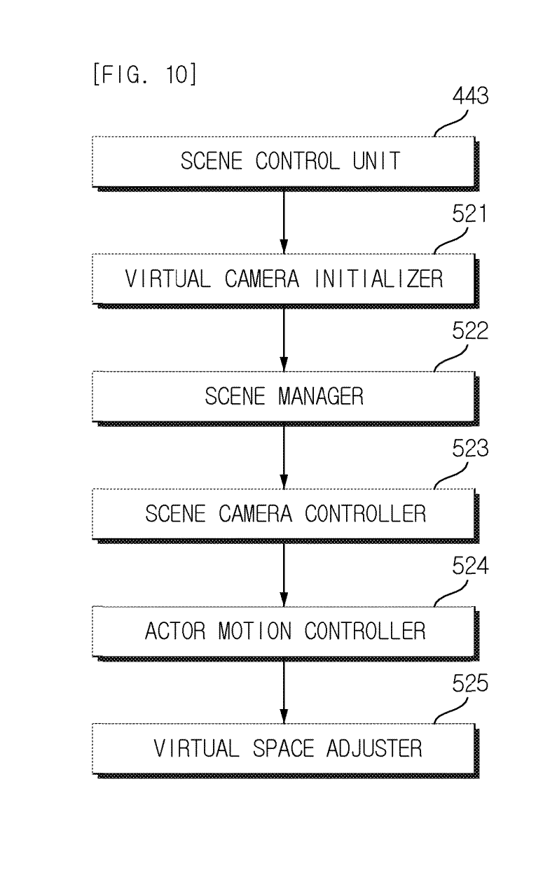

FIG. 10 is a block diagram showing an internal configuration of the scene control unit. As shown in FIG. 10, the scene control unit 443 includes a camera initializer 521 matching initial direction and position of a virtual shooting device positioned in the real space with the virtual camera in the virtual space, a scene manager 522 reading a predesigned virtual space scene data to configure the virtual space, a scene camera controller 523 controlling a position, a direction, and attributes of the camera in the virtual space according to the collected camera tracking information, and a virtual space adjuster 525 matching a unit of the scene data constituting the virtual space with that of the collected tracking information of the camera device.

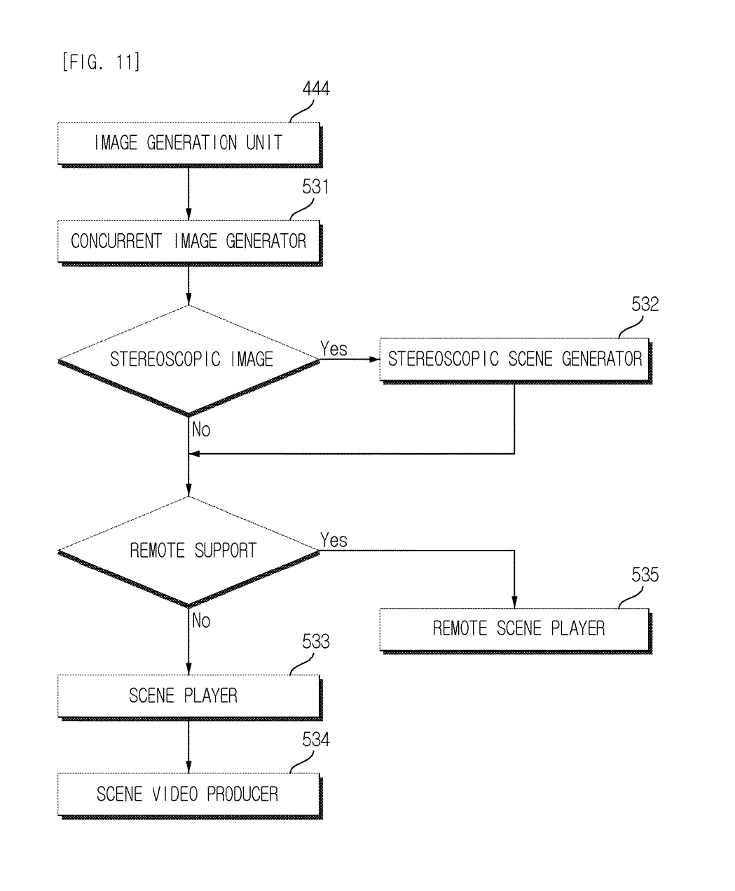

FIG. 11 is a block diagram showing an internal configuration of the image generation unit. As shown in FIG. 11, the scene generation unit 444 includes a concurrent image generator 531 combining in real-time scene model data, camera tracking information, and actor motion information to generate an image and then output a result of the image to a screen device of the virtual camera device and a monitor of the image server concurrently, a stereoscopic scene generator 532 generating a 3D stereoscopic image according to a user's designation, a scene player 533 providing a playing function for watching the image again at any time on the basis of the motion information and the virtual shooting device 430 which are managed by the camera tracking information manager 423 and the actor motion manager 413, a remote scene player 535 allowing a production director or investor, who is far away, to watch the image over the Internet, and a scene video producer 534 storing the played image which is a video file.

The data compatibility support unit 445 supports compatibility for various uses by providing a function of outputting information based on a standard format such that the collected camera tracking information and actor motion information may be utilized in an existing commercial program such as Maya and 3D Max.

The pre-visualization apparatus 400 will be described below with reference to FIGS. 4 to 11. In the embodiment, a user produces a virtual camera device including a screen output, attaches a marker to the virtual camera device, and then tracks a position of the camera.

The pre-visualization apparatus 400 includes the virtual shooting device 420 collecting virtual camera device information, the actor motion track unit 410 collecting the actor motion information, the data post-processing unit 441 managing and processing the transmitted data, the virtual camera attribute control unit 442 controlling attributes of the camera in the virtual space, a scene control unit 443 controlling the virtual space to be configured, an image generation unit 444 generating a final image, and a data compatibility support unit 445.

The virtual shooting device tracking unit 420 is operated as follows. When the virtual shooting device equipped using a marker is moved in a designated space, the camera tracker 421 tracks a position and direction of the virtual shooting device 430 using a marker tracking camera in the space, and the camera tracking information transmitter 422 transmits the collected camera motion information to the image server over the network. The actor motion tracking unit 410 is operated as follows. When an actor equipped using a marker in the designated space performs an operation, the actor motion tracker 411 extracts a motion of the actor using the marker tracking camera, and the actor motion transmitter 412 transmits the motion information to the image server. The transmitted and extracted data is stored and managed by the camera tracking information manager 423 and the actor motion manager 413.

Since the virtual shooting device is manually moved, the stored camera tracking information may have noise which is generated due to hand-shaking. If the camera tracking information with noise is used as it is, some problems such as degradation in quality of the image may be caused. The data post-processing unit 441 solves this problem. First, the tracking information manager 423 manages the camera tracking information and actor motion information on the basis of extraction time t, where camera position and direction information from time t1 to time t2 is stored on the basis of the predetermined time period Δt. The camera tracking information post-processor 501 removes noise or corrects a value through a post-processing function f(t, i) for the position and direction of the camera at a stored specific time C(t) to generate correction camera information C′(t). C′(t) may be found in Equation 1.

$${C}^{′} ( t ) = {\sum }_{i = 1}^{n} f ( t , i ) \qquad [ Equation 1 ]$$

The motion information post-processor 502 solves a problem caused by a physique difference between a real actor, from which a motion is extracted, and a digital actor during a process of transition of the extracted motion information to the 3D digital actor in the virtual space.

The virtual camera attribute control unit 442 controls an attribute of the virtual camera, which serves as a camera in the virtual space, and provides two operating modes. The camera attribute screen controller 511 controls such that a server operator may modify an attribute of the camera through a screen interface in the image server and the result screen may be output to the virtual camera device. Actually, a virtual camera operator has no authority for changing the attribute, and can only watch the screen. The camera attribute wireless controller 512 supports a function where the virtual shooting device operator may directly control the camera attribute. The camera operator may directly control FOV or Zoom In/Out of the camera on the basis of a wireless control device having the virtual shooting device.

The scene control unit 433 manages model data needed to establish the virtual space and then composes the scene The virtual camera initializer 521 calculates and corrects a difference between an initial position in the virtual space and a position in the real space. That is, this operation is to match motion (position, direction) of the virtual shooting device in the real space with that of the virtual camera in the virtual space. When the virtual camera is positioned in the virtual space, the camera has a position value (Origin(Position)) and a direction value (Origin(Direction)). The virtual camera initialization unit 521 determines a correction reference value (CorrBase(Position, Direction)) to process the position and direction values as an origin and a direction (Init(Position, Direction)). In the next scene, the position and direction (CorrValue(Position, Direction)) of the camera is corrected by correcting the camera position value (Extract(Position, Direction)) extracted in the spaced with the correction reference value (CorrBase(Position, Direction)). This is expressed as the following equation.

CorrBase(Position,Direction)=Origin(Position,Direction)−Init(Position,Direction)

CorrValue(Position,Direction)=Correction(CorrBase(Position,Direction),Extract(Position,Direction))

The scene manager 522 supports loading/control functions such that model data for establishing the virtual space pre-designed with a program such as Maya or 3D-Max may be output to a screen of the virtual shooting device. The model data may be loaded on the screen and selected through an UI. A position of the model data may be designated. An existing virtual studio can use only a predetermined scene space. However, the pre-visualization apparatus 400 allows an operator to freely change data composing the scene if necessary.

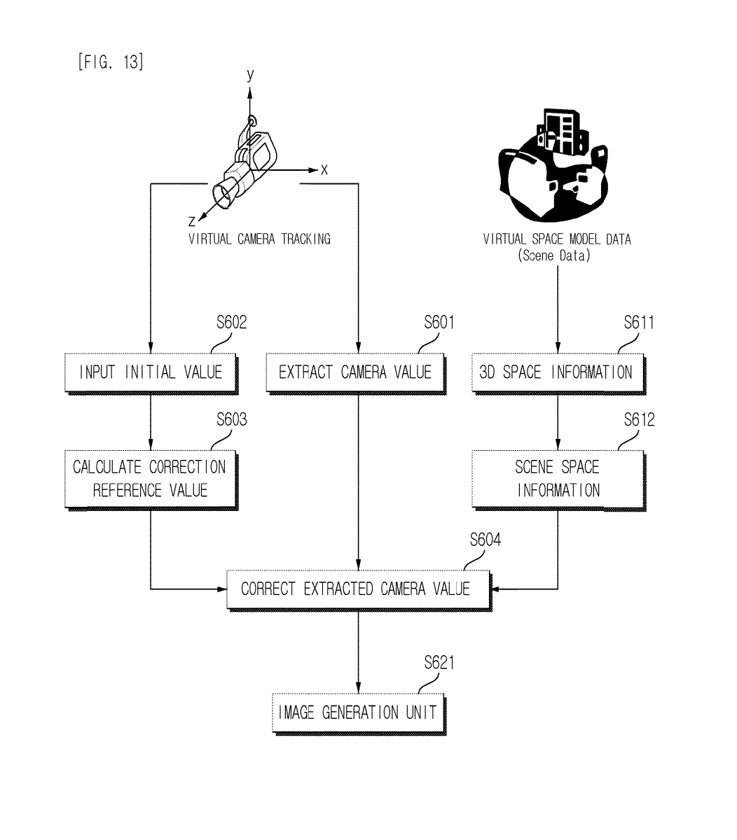

The scene camera controller 523 sets the attribute of the camera in the virtual space to generate the image on the basis of the camera tracking information (position, direction, FOV, etc.) which is collected by the virtual shooting device tracking unit 420 and stored through the data post-processing unit 441. The actor motion controller 524 applies the collected actor motion information to the digital actor in the virtual space to control the action of the digital actor. In this case, the collected virtual shooting device motion information and actor motion information are determined according to a specification of a hardware device used for tracking, and generally have a unit of mm. However, a desired scene, which is represented in the image, may be of a tall building with 10 floors or a small room with 10 cm in width and length. The scene may be of an open field or a rough mountain for battle scene. However, since the actual shooting space is much narrower and smaller, the virtual space adjuster 525 performs an operation for matching the unit therebetween. The following description will be made with reference to FIG. 13. A position and a direction (S601) of a camera collected by the virtual shooting device tracking unit 420 is corrected during a correction procedure with a correction reference value (S602, S603) calculated by the virtual camera initializer 521 to generate a correction value (CorrValue(Position, Direction))(S604). The scene camera controller 523 calculates final camera information to be used in the scene through a scene adjustment function (SceneScalar)(S621). In this case, an adjustment reference value is determined through scene data (SceneData)(S611, S612) read by the scene manager 522. This is expressed as the following equation.

FinalValue(Position,Direction)=SceneScaler(CorrValue(Position,Direction),SceneData)

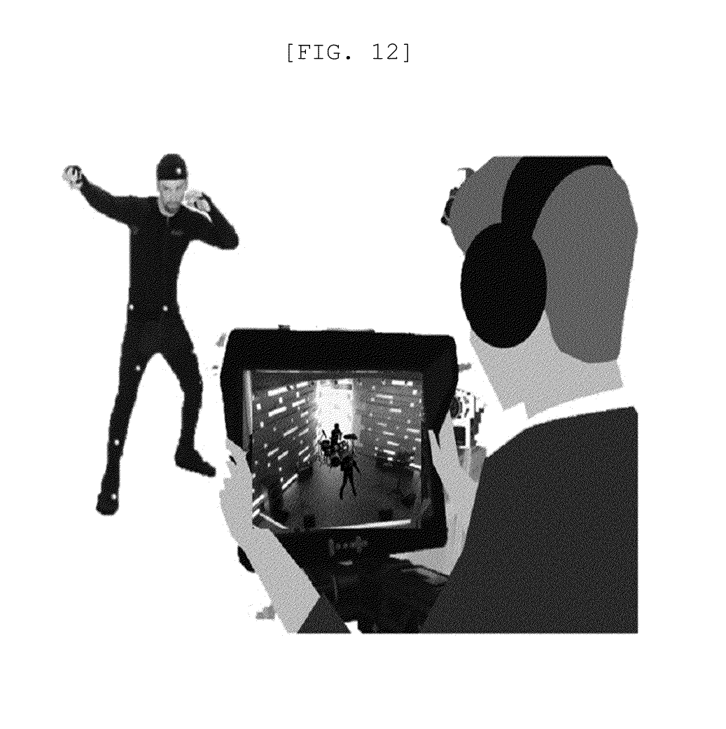

The image generation unit 444 is operated as follows. The concurrent image generator 531 combines in real-time composed scene data, camera tracking correction information, and actor motion information to generate an image and then concurrently output the result a screen device of the virtual shooting device 430 and a monitor of the image server. This allows the same image to be provided for a camera director who moves a camera device in an image production site and an image director who is responsible for the entire image production, thereby providing a production environment useful for image production. FIG. 12 is a conceptual view illustrating a process of generating an image by combining the extracted actor's motion, and outputting the image on a screen of the virtual shooting device.

The stereoscopic scene generator 532 supports a stereoscopic image to an image rendering server and an image of the virtual camera device in order to support a recent stereoscopic image production environment. An operator simulates a virtual stereo camera in the virtual space on the basis of the stored camera tracking information and thus a pre-visualization image for the stereoscopic image is provided. Especially, since a screen may be checked while changing a distance and a zero point value between left/right cameras, the setting of the stereoscopic camera is projected to be suitable for the scene, and is utilized as base data for the shooting in an actual shooting step.

The scene player 533 provides a playing function for watching the image again at any time on the basis of the motion information and the virtual shooting device 430 which are managed by the camera tracking information manager 423 and the actor motion manager 413. The remote scene player 535 allows a production director or investor, who is far away, to watch the image over the Internet. The scene video producer 534 stores the played image which is a video file.

The data compatibility support unit 445 supports compatibility for various uses by providing a function of outputting information based on a standard format such that the collected camera tracking information and actor motion information may utilized in an existing commercial program such as Maya and 3D Max.

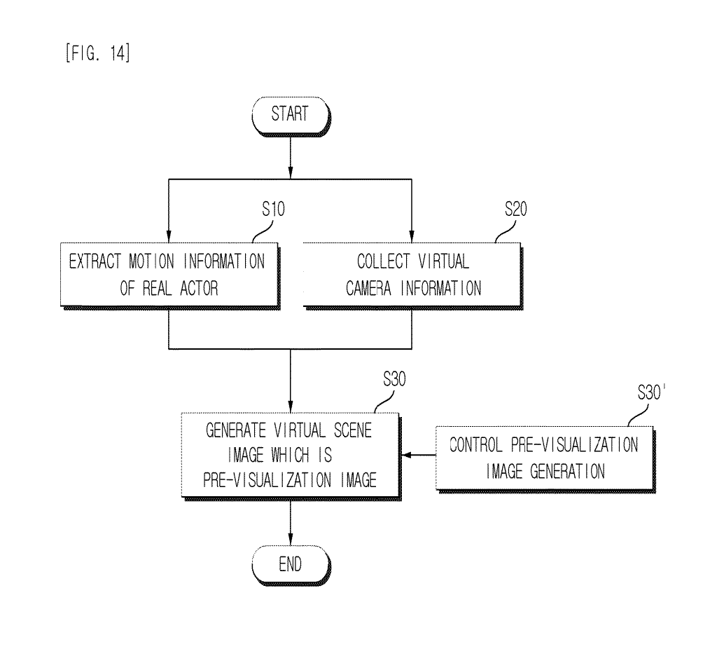

Next, a method of generating the pre-visualization image with the pre-visualization image generation apparatus 100 will be described. FIG. 14 is a flow chart schematically showing a method of the pre-visualization image according to an exemplary embodiment of the present invention. The following description will be made with reference to FIG. 14.

First, a motion information extraction unit extracts motion information about a real actor (S10). In step S10, the motion information extraction unit may extract the motion information using a marker attached to the real actor.

After step S10, a device information collection unit collects virtual camera information which is motion information about a virtual shooting device for shooting the motion of the real actor (S20). Step S20 may be performed as follows. First, the virtual shooting device tracker tracks the motion of the virtual shooting device using a marker attached to the virtual shooting device in the real space. Next, a position/direction information collector collects position or direction information about the virtual camera, which is the virtual shooting device information by tracking the virtual shooting device.

After step S20, a pre-visualization image generation unit applies the motion information about the actor positioned in the real world on the digital actor on the basis of the virtual shooting device information to generate the pre-visualization image which is a virtual scene image containing the motion of the digital actor (S30).

Between step S20 and step S30, the image generation control unit performs a control function such that the pre-visualization image can be generated (S30′).

Before step S20, the virtual camera information initialization unit may perform a step of calculating relative position and direction difference values between the real shooting device in the real space and the virtual shooting device in the virtual space and then initializing correction information about the virtual shooting device with the difference values. As an example, this step may be performed between step S10 and step S20. The image generation control unit may correct the virtual camera information with the virtual camera value which is initialized whenever the motion information is extracted, to control the virtual camera in step S30′ according to the driving of the virtual camera information initialization unit.

After step S10, a motion information correction unit may perform a step of correcting the motion information to be applicable to the digital actor. As an example, this step may be performed between step S10 and step S20.

After step S20, a virtual camera information correction unit may perform a step of correcting virtual camera information with noise removal or sample simplification. As an example, this step may be performed between step S20 and step S30.

After step S20, a virtual camera control unit may perform a step of controlling an attribute of the virtual camera device through a screen interface or wireless controller. As an example, this step may be performed between step S20 and step S30.

After step S40, the compatible data conversion unit may perform a step of converting at least one of the motion information of the real actor, the virtual camera information, a virtual scene image, and a pre-visualization image into compatible data.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for generating a pre-visualization image comprising:
a motion information extraction unit extracting motion information about a real actor;
a device information collection unit collecting virtual camera information, the virtual camera information being motion information about a virtual shooting device for shooting the motion of the actual actor;
a pre-visualization image generation unit applying the motion information of the actor to the digital actor on the basis of the virtual camera information to generate a pre-visualization image, the pre-visualization image being a virtual scene image containing the motion of the digital actor; and
a image generation control unit performing control such that the pre-visualization image is generated.

2. The apparatus of claim 1, wherein the device information collection unit comprises:
a virtual shooting device tracker tracking the motion of the virtual shooting device using a marker attached to the virtual shooting device; and
a position/direction information collector collecting position and direction information about the virtual camera through the tracking, the position and direction information being the virtual camera information.

3. The apparatus of claim 1, wherein the motion information extraction unit extracts the motion information using a marker attached to the real actor.

4. The apparatus of claim 1, further comprising:
a motion information correction unit correcting the motion information such that the motion information is applicable to the digital actor; or
a virtual camera information correction unit correcting the virtual camera information with noise removal or sample simplification.

5. The apparatus of claim 1, further comprising:
a virtual camera attribute control unit controlling an attribute of the virtual camera through a screen interface or wireless controller.

6. The apparatus of claim 1, wherein the image generation control unit comprises:
a virtual model data manager pre-generating or storing virtual model data, the virtual model data being a virtual model to be disposed in a virtual space;
a virtual camera controller controlling the virtual camera in the virtual space using the virtual camera information collected whenever the motion information of the virtual shooting device is extracted;
a digital actor controller applying the motion information to the digital actor positioned in the virtual space to control the digital actor;
a virtual space controller controlling the virtual space by adjusting a size or shape of the virtual space using the controlled virtual camera; and
a combination-based scene image generation controller performing control such that the pre-visualization image is generated, by combining the controlled digital actor and virtual camera with the virtual model data in the controlled virtual space.

7. The apparatus of claim 6, wherein the image generation control unit further comprises a virtual camera information initializer calculating relative differences in position and direction between the real shooting device in the real space and the virtual camera in the virtual space and initializing correction information about the virtual camera with the differences, and
the virtual camera controller controls the virtual camera by correcting the virtual camera information using a virtual camera value initialized whenever the motion information is extracted.

8. The apparatus of claim 6, wherein the combination-based scene image generation controller performs control such that the pre-visualization image, which is a stereoscopic image, is generated on the basis of the virtual camera information.

9. The apparatus of claim 6, wherein the combination-based scene image generation controller performs control such that the pre-visualization image is simultaneously output with multiple screens to the virtual shooting device and the image generation unit.

10. The apparatus of claim 9, wherein the combination-based scene image generation controller performs remote control over a network such that a preview image is output to the multiple screens.

11. The apparatus of claim 1, further comprising:
a compatible data conversion unit converting at least one of the motion information, the virtual camera information, the virtual scene image, and the pre-visualization image into compatible data.

12. A method of generating a pre-visualization image comprising:
a motion information extraction step of extracting motion information about a real actor;
a virtual shooting device information collection step of collecting virtual camera information, the virtual camera information being motion information about a virtual shooting device for shooting the motion of the real actor; and
a pre-visualization image generation step of applying the motion information of the actor to the digital actor on the basis of the virtual camera information to generate a pre-visualization image, the pre-visualization image being a virtual scene image containing the motion of the digital actor.

13. The method of claim 12, wherein the virtual shooting device information collection step comprises:
a virtual shooting device tracking step of tracking the motion of the virtual shooting device using a marker attached to the virtual shooting device of the real space; and
a position/direction information collection step of collecting position and direction information about the virtual camera, the position and direction information being the virtual camera information through the tracking, or
the motion information tracking step comprises extracting the motion information using the marker attached to the real actor.

14. The method of claim 12, further comprising:
a motion information correction step of correcting the motion information such that the motion information is applicable to the digital actor; or
a virtual camera information correction step of correcting the virtual camera information with noise removal or sample simplification.

15. The method of claim 12, further comprising:
a virtual camera attribute control step of controlling an attribute of the virtual camera through a screen interface or wireless controller.

16. The method of claim 12, further comprising:
a pre-visualization image generation control step of performing control such that the pre-visualization image is generated.

17. The method of claim 16, further comprising:
a virtual camera information initialization step of calculating relative differences in position and direction between the actual shooting device in the real space and the virtual camera in the virtual space and initializing correction information about the virtual camera with the differences,
wherein the pre-visualization image generation control step comprises controlling the virtual camera by correcting the virtual camera information using a virtual camera value initialized whenever the motion information is extracted.

18. The method of claim 12, further comprising:
a compatible data conversion step of converting at least one of the motion information, the virtual camera information, the virtual scene image, and the pre-visualization image into compatible data.
